(19) United States
(12) Patent Application Publication
(10) Pub. No.: US 2006/0219771 A1
(43) Pub. Date: Oct. 5, 2006

(54) Position searching system for electronic devices and method using the same

(75) Inventor: Shan-Fa Shih, Taipei (TW)

Correspondence Address: EDWARDS & ANGELL, LLP, P.O. BOX 55874, BOSTON, MA, 02205, US

(73) Assignee: Inventec Corporation, Taipei (TW)

(21) Appl. No.: 11/096,296

(22) Filed: Mar. 31, 2005

(51) Int. Cl. G06F 7/00

(52) U.S. Cl. 235/376

(57) ABSTRACT

A position searching system for electronic devices and a method for using the same applicable to a run-in test of a production line are proposed. The position searching system includes bank identification codes, electronic devices, scanning devices and a server. The bank identification codes are affixed to each bank of the run-in stand for receiving the electronic devices during the run-in test. Each electronic device displays a unique device identification code on its display. Each device identification code and the respective bank identification code that identifies the corresponding bank in which the electronic device is placed are scanned into the scanning device, then the scanned codes are correspondingly stored and shown by the server, thereby allowing production line staff to determine the locations of the electronic devices by referring to the corresponding location and device identification codes shown in the table.

### FIELD OF THE INVENTION

The present invention relates to a position searching technology for electronic devices, and more particularly, to a position searching system and method that performs position searching for electronic devices during a run-in operation in a production line.

### BACKGROUND OF THE INVENTION

Information technology is applied extensively everywhere, therefore demands for information devices are getting increasingly bigger. Especially, market demands for notebooks and personal computers are even much bigger. For manufacturers of notebooks and personal computers who, on one hand, wish to raise productions in order to make more profit, on the other hand, have to control the quality of the product in order to establish better goodwill. Therefore, in order to assure the quality of the products, usually after a notebook has been made, a certain period of time for functional test is required, such as memory accessing test or terminal mode of central processing unit test etc., to determine the normality of computer functionality and stability. The time for the functional test normally is 24 to 48 hours or more than 72 hours. This functional test is called a run-in test.

However, there are generally about three hundred banks in a run-in stand for receiving electronic devices therein for function testing. The present arrangement is that whenever there is an empty bank, an electronic device to be tested is placed at that bank in order for a run-in test to be performed. This makes it more difficult for a staff of the product line to know where the electronic device is, especially, when a specific model is needed urgently, the required electronic device is often unable to be found immediately, since the required electronic device is only found after searching through the banks one after the other. Therefore, shipment time is delayed and production cycle is prolonged.

Therefore, there is a need for a technology that allows a production line staff to know immediately the location of an electronic device in a run-in area.

### SUMMARY OF THE PRESENT INVENTION

In view of the foregoing technical drawbacks, a main objective of the present invention is to provide a position searching system and method for electronic device so that product flow is enhanced and production cycle is shortened. Another objective of the present invention is to provide a position searching system and method that enables production line staff to easily determine the location of an electronic device ready to be shipped in a run-in stand.

A further objective of the present invention is to provide a position searching system and method for electronic devices that enables the production line staff to easily count the number of electronic devices in the run-in stand.

In accordance with above and the other objectives, the present invention provides a position searching system and method for electronic devices. The position searching system for electronic devices suitable for a run-in operation of production line, the system comprising: a plurality of bank identification codes that are each attached to one of the banks of a run-in stand for receiving the electronic devices and uniquely identifies the bank to which it is attached, wherein the electronic devices is provided with a device identification code that uniquely identifies the electronic device on which it is shown; at least one scanning device that is used to scan and read the device identification codes of the electronic devices and the bank identification codes of the banks receiving the electronic devices; and a server that is connected to the at least one scanning device and is used to store and process the result scanned by the scanning device to generate a table showing the device identification code of the electronic devices and their corresponding bank identification codes respectively.

The position searching method for electronic devices suitable for a run-in operation of production line, the method comprising the following steps of: (1) providing a plurality of unique bank identification codes and attaching them to banks in a run-in stand for receiving the electronic devices; (2) placing the plurality of electronic devices in the banks of the run-in stand, each of the electronic devices being provided with a device identification code that uniquely identifies the electronic device on which it is shown; (3) scanning and reading the device identification codes of the electronic devices and the bank identification codes of the banks receiving the electronic devices; and (4) generating a table showing the device identification code of the electronic devices and their corresponding bank identification codes respectively.

Compared to the prior art, the position searching system and method of the present invention, which allow the production line staff to easily find the location of an electronic device in the run-in stand during run-in operation and count the quantity of electronic devices in the stand, accelerates production flow and shortens production cycle to enhance production efficiency.

### BRIEF DESCRIPTION OF THE DRAWINGS

The present invention can be more fully understood by reading the following detailed description of the preferred embodiments, with reference made to the accompanying drawings, wherein:

FIGS 1 is a block diagram showing a basic structure of a position searching system for electronic devices of the present invention; and

FIGS. 2 is a flow chart showing a procedure flow of a position searching method for electronic devices of the present invention.

### DETAILED DESCRIPTION OF THE PREFERRED EMBODIMENTS

Reference will now be made in detail to the preferred embodiment of the present invention, the advantages and functions of the present invention can be understood by those skilled in the art after reading the detailed description. The present invention should cover various modifications and variations made to the herein-described structure and operations of the present invention, provided they fall within the scope of the present invention.

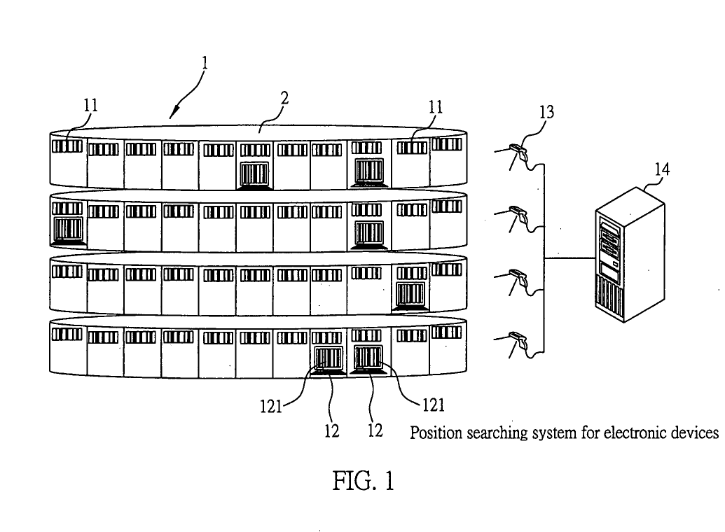

FIG. 1 is a block diagram showing a basic structure of the position searching system for electronic devices of the present invention. In this embodiment, the position searching system for the electronic device 1 of the present invention is applied to a run-in stand 2 for performing a run-in operation. As shown in the diagram, the position searching system for the electronic device 1 of the present invention comprises a plurality bank identification codes 11, a plurality of electronic devices 12, scanning devices 13 and a server 14.

The bank identification code 11 is affixed on each bank of the run-in stand 2 and is unique. Each bank identification code 11 represents the location to which it is affixed. In this embodiment, the bank identification code is a bar code.

The electronic devices 12 having displays are placed in the banks of the run-in stand 2. In this embodiment, the electronic device 12 is a notebook needed to be tested of a production line, the display of the electronic device 12 shows an unique device identification code 121 identifying the electronic device 12 during the run-in test. In this embodiment, the device identification code 121 is a bar code.

The scanning devices 13 are fixed around the run-in stand 2, which are used to scan and read each bank identification code 11 of the banks and the device identification code 121 shown on the displays of the electronic devices placed in each bank. In this embodiment, the run-in stand 2 has multiple stacks. Therefore, there is a plurality of scanning devices 13, where each layer has a corresponding scanning device 13. During the run-in test, the run-in stand 2 automatically rotates, and the scanning and reading operation of all bank identification codes 11 and the device identification codes 121 on the display of the electronic device is completed after one rotation. In this embodiment, the scanning device 13 is a bar code reader, the details of how scanning and reading operation is completed is a well know technology, thus no further descriptions will be given.

The server 14 is connected to the scanning devices 13 and is used to store and process results scanned by the scanning devices 13. In this embodiment, the server 14 can produce a table, wherein each device identification code 121 shown on the display of electronic devices 12 uniquely corresponds to a bank identification code 11. Therefore, the production line staff can always know in which bank an electronic device is currently placed.

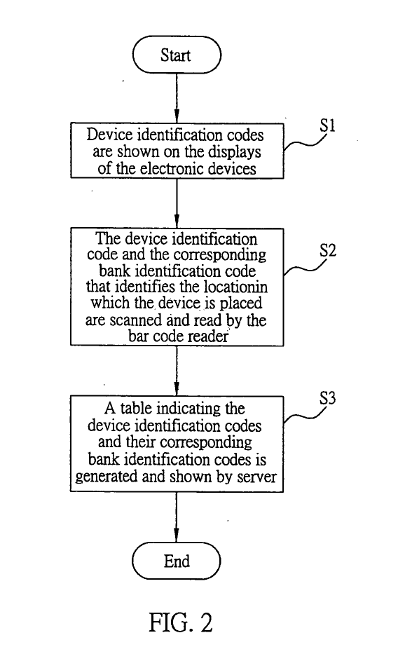

FIG. 2 is a flow chart illustrating the procedure flow of the position searching method for electronic devices of the present invention. As shown in the diagram, step S1 is entered after starting a run-in test. At step S1, the bar code (device identification code) 121 is shown on the display of the electronic device 12, then moving on to step S2.

At step S2, the bar code 121 shown on the display of each electronic device 12 and the bank identification code 11 receiving the corresponding electronic device 12 are read by the bar code reader 13, then moving to step S3.

At step S3, the bar code information accessed by the bar code reader 13 is processed by the server 14, then a table including the bar code 121 of each electronic device 12 and its corresponding bank identification code 11 is generated and displayed.

Referring to the above descriptions, the position searching system and method for the electronic devices can accelerate production flow and shorten production cycle by enabling production line staff to easily find the electronic devices in the run-in stand and count the number of electronic devices on the stand.

The present invention has been described using exemplary preferred embodiments. However, it is to be understood that the scope of the present invention is not limited to the disclosed embodiments. On the contrary, it is intended to cover various modifications and arrangements. The scope of the claims, therefore, should be accorded then broadest interpretation so as to encompass all such modifications and similar arrangements.

What is claimed is:

1. A position searching system for electronic devices suitable for a run-in operation of production line, the system comprising:
a plurality of bank identification codes that are each attached to one of a plurality of banks of a run-in stand for receiving the electronic devices and used to uniquely identify the bank attached therewith;
wherein the electronic devices are each provided with a device identification code that uniquely identifies the electronic device on which it is shown;
at least one scanning device that is used to scan and read the device identification codes of the electronic devices and the bank identification codes of the banks receiving the electronic devices; and
a server that is connected to the at least one scanning device and is used to store and process scanning the obtained scanned by the scanning device to generate a table showing the device identification codes of the electronic devices and their corresponding bank identification codes respectively.

2. The position searching system for electronic devices of claim 1, wherein the electronic devices are notebook computers.

3. The position searching system for electronic devices of claim 1, wherein the run-in stand is a multiple layered structure.

4. The position searching system for electronic devices of claim 3, wherein each layer of the run-in stand is provided with a corresponding one of the scanning devices.

5. The position searching system for electronic devices of claim 1, wherein the scanning devices are fixed onto the run-in stand.

6. The position searching system for electronic devices of claim 1, wherein the bank identification codes are bar codes.

7. The position searching system for electronic devices of claim 1, wherein the device identification code for the electronic device are bar codes.

8. The position searching system for electronic devices of claim 1, wherein the scanning devices are bar code readers.

9. A position searching method for electronic devices suitable for a run-in operation of a production line, the method comprising:
providing a plurality of unique bank identification codes and attaching them to banks in a run-in stand for receiving the electronic devices;
placing the electronic devices in the banks of the run-in stand, each of the electronic devices being provided a device identification code that uniquely identifies the electronic device on which it is shown;
scanning and reading the device identification codes of the electronic devices and the bank identification codes of the banks receiving the electronic devices; and
generating a table showing the device identification codes of the electronic devices and their corresponding bank identification codes respectively.

10. The position searching method for electronic devices of claim 9, wherein the electronic devices are notebook computers.

11. The position searching method for electronic devices of claim 9, wherein the run-in stand is a multiple layered structure.

12. The position searching method for electronic devices of claim 11, wherein each layer of the run-in stand is provided with corresponds to a respective one of the scanning devices.

13. The position searching method for electronic devices of claim 9, wherein the bank identification codes are bar codes.

14. The position searching method for electronic devices of claim 9, wherein the device identification code for the electronic device are bar codes.
